(19) United States
(12) Patent Application Publication
(10) Pub. No.: US 2009/0112824 A1
(43) Pub. Date: Apr. 30, 2009

(54) METHOD AND APPARATUS FOR GENERATING PRESENTATION CONFIGURATION FILE OF DOCUMENT CONTENT

(75) Inventors: Rong Yao Fu, Beijing (CN); Hai Tao Long, Beijing (CN); Yuan Quan, Beijing (CN); Xia Tian Zhang, Beijing (CN); Shiwan Zhao, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 12/259,620

(22) Filed: Oct. 28, 2008

(30) Foreign Application Priority Data
Oct. 29, 2007 (CN) 200710167080.X

(51) Int. Cl. G06F 7/06; G06F 17/00; G06F 15/16; G06F 17/30

(52) U.S. Cl. 707/3; 715/273; 709/203; 707/100; 707/E17.014; 707/E17.044; 707/E17.01

(57) ABSTRACT

A method and an apparatus for generating presentation configuration files of document content, wherein the document content will be presented according to the presentation configuration files. The method may include acquiring one presentation configuration file template and updating the presentation file template according to personalized presentation rules associated with preferences input by a current user, to generate the presentation configuration files customized with respect to the current user. According to the present invention, the presentation configuration files can be generated automatically based on the user preferences, such that the document content can be presented according to the customized presentation configuration files.

### FIELD OF THE INVENTION

The present invention generally relates to the presentation of document content, and more particularly to a method and an apparatus for generating presentation configuration files of document content.

### BACKGROUND OF THE INVENTION

During the current procedure of designing and establishing a website, a scheme is usually adopted, in which the separation of web pages (for example, written in HTML or a similar markup language) from presentation configuration files (for example, written in Cascading Style Sheet: CSS) of web pages is enabled. Typically, this separation can improve web page accessibility, provide more flexibility and control in presentation style of page documents, and reduce the complexity in presentation of page documents and repeated manual labor.

The presentation configuration files of web pages are control files for defining the presentation style of web pages, wherein the presentation style of web pages usually refers to layout, background color, font color, font size, font style and other aspects of web pages. Presently the Cascading Style Sheet (CSS) is a most often used language for describing presentation configuration files of web pages. By using the above-mentioned presentation configuration files (for instance, a CSS file) of document content, same web page content can be presented in different styles so as to be suitable for different presenting methods such as displaying on screen, printing and the like.

At present, along with the popularization of personalized customization principle, more and more people desire to present web pages with their own customized presentation styles. Further, when browsing web pages, those users with visual impairments, such as color blindness, color weakness, amblyopia etc. for example, may encounter some difficulties in differentiating the font color and background color, making out fonts with a small size, or the like.

In the prior art, some web page content providers such as Discuz Forum* (*may be a trademark of the respective owner) give options for terminal users to select presentation styles of page documents. Usually, these presentation configuration files of document content are pre-stored in website servers, instead of being generated dynamically based on user preferences. This solution only needs to modify web page files at servers but not to make any modifications to browsers at clients. However, this solution has the following drawbacks of providing options with respect to pre-determined limited preferences but not dynamically reflecting users' real-time varying requirements.

One proposed solution in the prior art provides for the presentation styles of web pages being customized based on user preferences by adding some options to browsers at clients. As an example, the Internet Explorer *browser of Microsoft* cooperation is able to provide functions such as “select page font size” and the like. In this solution, only browsers at clients are required to be updated, thus avoiding the workload brought by modifying web page files at servers. However, this solution still has lots of limitations. Firstly, the provider of browser has to re-design functions of the browser, and then develop and test the functions to be added, in order to facilitate the browser in supporting the customization of presentation style of content. Secondly, respective customization modules of presentation style of content should be developed for different browsers such as Internet Explorer*, Netscape*, Firefox* etc., and thus a uniform standard should be negotiated between providers of different browsers.

Most of present websites don't provide services of customizing presentation styles of web pages with respect to different user preferences, that is, users can not adjust presentation styles of web pages dynamically according to the their preferences. Accordingly, it is desirable to provide an approach to automatically generate the presentation configuration files of document content based on user preferences. The approach should ensure that the workload brought by modifying configurations at the website server is as low as possible, and that it is unnecessary to modify the browser application itself at the client (e.g., using plug-in). In addition, the approach should preferably make the presentation style of web pages determined based on the same user preferences appear similar, even though the web pages are presented at various browsers (such as Internet Explorer, Netscape, Firefox and so on) running on operating systems as Windows, Linux* etc.

### SUMMARY OF THE INVENTION

To overcome the above-mentioned drawbacks in the prior art, the present invention provides a method and an apparatus for generating presentation configuration files of document content, which can dynamically generate the presentation configuration files customized based on user preferences, such that the document content can be presented according to the customized presentation configuration files.

According to one aspect of the present invention, a method for generating presentation configuration files of document content is provided, wherein the document content will be presented according to said presentation configuration files. The method may comprise the steps of acquiring one presentation configuration file template, and updating said presentation configuration file template according to personalized presentation rules associated with the preferences input by a current user, to generate the presentation configuration files customized with respect to said current user.

According to another aspect of the present invention, an apparatus for generating presentation configuration files of document content is provided, wherein the document content will be presented according to said presentation configuration files. The apparatus may comprise an acquiring means for acquiring one presentation configuration file template, and an updating means for updating said presentation configuration file template according to personalized presentation rules associated with the preferences input by a current user, to generate the presentation configuration files customized with respect to said current user.

According to still another aspect of the present invention, a method for generating personalized presentation rules is provided. The method comprises the steps of providing a user preference database for storing, in association with a user, user preferences; providing a user presentation configuration file property database, for storing, in association with the user, properties in the presentation configuration files of the user and their corresponding values; searching, according to the preferences input by the current user, a neighbor user whose preferences are the most similar to the preferences input by the current user from said user preference database; and acquiring, from said user presentation configuration file property database, said properties in the presentation configuration files of the neighbor user and their corresponding values, wherein the properties in the presentation configuration files of the neighbor user and their corresponding values are provided as said personalized presentation rules.

According to yet another aspect of the present invention, an apparatus for generating a personalized presentation rules is provided. The apparatus may comprise a user preference database for storing user preferences in association with the user; a user presentation configuration file property database, for storing, in association with the user, properties in the presentation configuration files of the user and their corresponding values; a neighbor finding means for searching, based on the preferences input by the current user, a neighbor user whose preferences are the most similar to said preferences input by the current user from said user preference database, and acquiring properties in the presentation configuration files of said neighbor user and their corresponding values from said user presentation configuration file property database, wherein the properties in the presentation configuration files of said neighbor user and their corresponding values are provided as said personalized presentation rules of said current user.

### BRIEF DESCRIPTION OF THE DRAWINGS

The features, advantages and other aspects will become more apparent in view of the following detailed description given with reference to the drawings, in which:

FIG. 1 is a schematic diagram showing network architecture where the present invention implements;

FIG. 2 is a schematic diagram showing the architectures of client and server sides of network architecture according to the first embodiment of the present invention;

FIG. 3 illustrates operating processes of server side of the network architecture as shown in FIG. 2 according to the first embodiment of the present invention;

FIG. 4 is a schematic block diagram showing an exemplary architecture of a generating means of FIG. 2 according to the first embodiment of the present invention;

FIG. 5 is operating processes of the generating means of FIG. 2 according to the first embodiment of the present invention;

FIG. 6 is a schematic diagram showing the architectures of client and server sides of a network architecture according to the second embodiment of the present invention; and

FIG. 7 is a flow chart showing a method for generating personalized presentation rules in the second embodiment of the present invention.

It should be appreciated that, same parts are indicated by same reference numbers in all drawings.

### DETAILED DESCRIPTION OF THE INVENTION

The basic principle of the present invention comprises that customized presentation configuration files of document content can be generated automatically based on user preferences, such that the document content is presented according to the customized presentation configuration files of the document content.

For description, web pages are used as an example of document content in the description of embodiments of the present invention. However, those skilled in the art should appreciate that the present invention is also applicable to document contents in any other forms, besides web pages. Furthermore, CSS files are an example of presentation configuration files of document content in the description of the following embodiments of the present invention. But, those skilled in the art should understand that besides CSS files, the present invention is also applicable to presentation configuration files of document content in any other form.

The detailed descriptions of embodiments of the present invention are given as follows with reference to drawings.

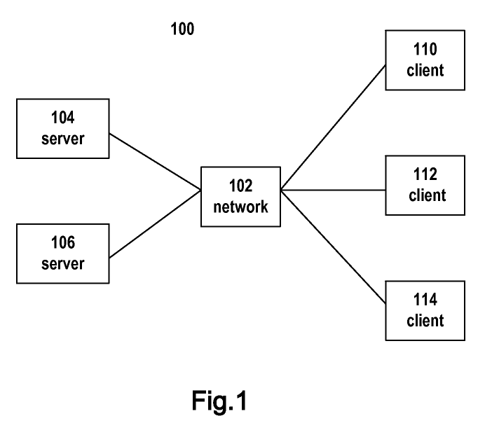

Refer to FIG. 1, a simplified diagram showing network architecture 100 for the present invention is illustrated. The network architecture 100 may include servers 104 and 106, a network 102 and clients 110, 112 and 114. The network 102 comprises media for providing communication links between the servers 104, 106 and clients 110, 112 and 114, and may include various connection types, for example, wired or wireless communication links, optical fiber cable, etc.

The servers 104 and 106 can be those servers with webpage applications installed thereon and which operate as portals through which terminal users can access webpage resources. Users may access web pages stored on the servers 104 and 106 through a Uniform Resources Locator (URL) address.

The clients 110, 112 and 114 can be terminal apparatus with a webpage browser application installed thereon, for example, a desk computer, laptop, mobile phone, personal digital assistant etc., and they can operate under such operating system environments as Windows, Linux etc. The webpage browser applications may comprise such browser applications as Internet Explorer, Netscape, Firefox and the like. Generally, the clients 110, 112 and 114 can access, via the network 102, web pages on the servers 104 and 106 by the browser applications installed thereon. It should be appreciated that the number of servers, networks and clients in FIG. 1 is only for illustration. There can be any number of servers, networks and clients according to real requirements.

### A First Embodiment

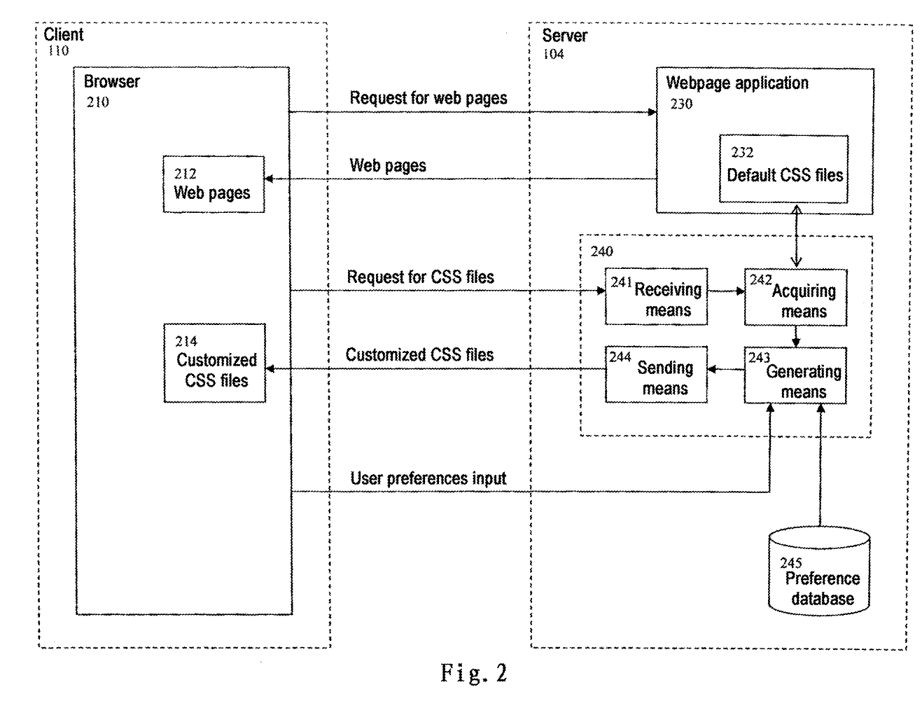

Referring to FIG. 2, a schematic diagram shows architectures of client and server sides of a network architecture according to the first embodiment of the present invention.

Specifically, as shown in FIG. 2, a browser 210 is provided at the client 110, and a webpage application 230 at the server 104. The user can send a request for web pages to the webpage application 230 at the server 104 through the browser 210. Upon reception of the request, the webpage application 230 returns to the browser 210 the web pages 212 corresponding to the request.

Traditionally, after this, the browser 210 will analyze the returned web pages 212 in order to find out, by parsing, an external link address of the CSS files (i.e., presentation configuration files) required for presenting the web pages 212, and then send a request for CSS files to the webpage application 230 at the server 104. The webpage application 230 finds out, through a corresponding relationship between the web pages stored in the webpage application 230 and the CSS files, the default CSS files 232, and returns the default CSS files to the browser 210 at the client 110. After receiving both the web pages 212 and the default CSS files, the browser presents, at the browser 210, the web pages 212 according to the document presentation style defined in the default CSS files 232. The above processes are well-known, so the description thereof is omitted.

What is different from the prior art is that, according to the embodiment of the present invention, when the browser 210 sends the request for CSS files to the server 104, the returned files are not the default CSS files but are files customized based on user preferences. That is to say, in the embodiment, the server 104 is able to customize the CSS files 214 (i.e., the presentation configuration files of document content) of the web pages 212 based on specific preferences input by the user, and return the customized CSS files 214 to the browser 210 at the client 110 so that the web pages 212 are presented at the browser 210 according to the customized CSS files 214.

Specifically, as shown in FIG. 2, the server 104 according to the embodiment of the present invention may include a receiving means 241, an acquiring means 242, a generating means 243 and a sending means 244.

The receiving means 241 receives from the browser 210 at the client 110 the request for CSS files. The acquiring means 242 can acquire the default CSS files (i.e., the default CSS files in the existing technology) corresponding to the request from the webpage application 230 based on the request, as a CSS file template.

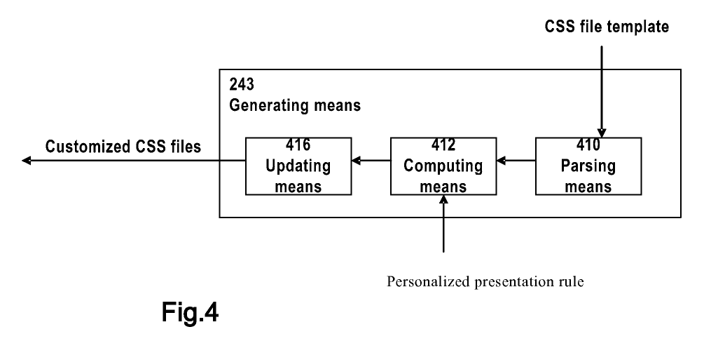

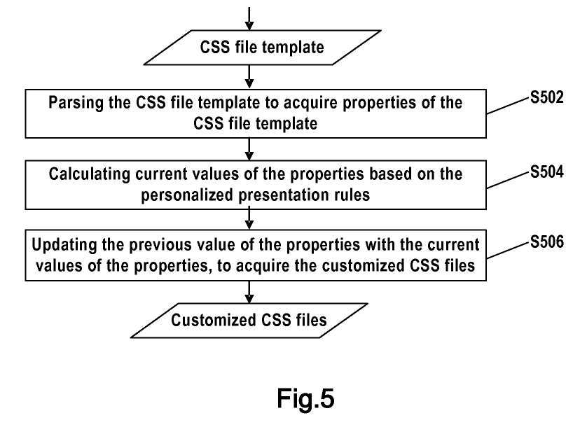

The generating means 243 receives the CSS file template from the acquiring means 242, and updates the CSS files according to personalized presentation rules associated with the preferences input by the current user to generate the CSS files customized by the current user. The architecture and operations of the generating means 243 are described as follows with reference to FIG. 4 and FIG. 5.

Now, a description is given according to the user preferences and the personalized presentation rules of the present invention. In the present invention, the personalized presentation rule describes the rule desired to be used when the user browses web pages. The personalized presentation rules may, for example, comprise “big font/bold; font size is scaled to be 200% of normal size/bold”, “display according to grey scale: color: #000000, background: #FFFFFF” etc. The user preference may comprise amblyopia, red-green blindness, gender, age and so on. There is a corresponding relationship between a user preference and an personalized presentation rule. As an example, the preference “amblyopia” corresponds to the rule “big font/bold; font size is scaled to be 200% of normal size/bold”, while the preference “red-green blindness” corresponds to the rule “display according to grey scale: color: #000000, background: #FFFFFF” etc. Usually, the corresponding relationship between the preferences and the personalized presentation rules can be acquired through a statistical method.

Alternatively, the corresponding relationship between the preferences and the personalized presentation rules can be pre-provided in the generating means 243. Thus, when the user inputs his/her preferences, the generating means 243 is able to generate the customized presentation configuration files by utilizing the personalized presentation rules corresponding to the preferences.

Still alternatively, as shown in FIG. 2, a preference database 245 may be provided at the server 104, for storing, in association with preferences, personalized presentation rules. When starting up, the server 104 can load the preference database into the generating means 243 automatically.

Those skilled in the art should understand that, the preference database 245 may be provided at a client or proxy server (not shown) as well, not necessarily at the server 104.

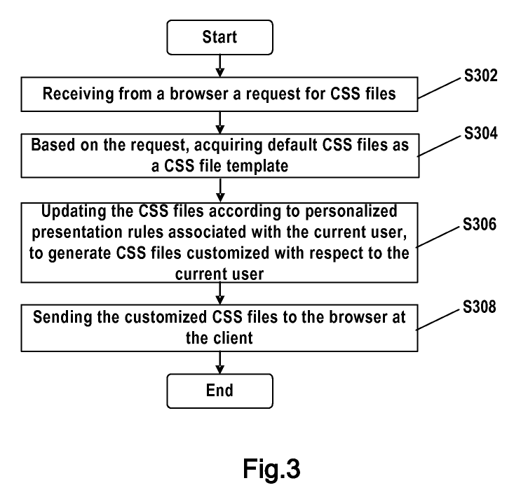

Hereinafter, with reference to FIG. 3, a detailed description is given of operating processes on the server side of the network architecture as shown in FIG. 2 according to the first embodiment of the present invention.

As shown in FIG. 3, at step S302, the receiving means 241 receives a request for CSS files from the browser 210 at the client 110.

Next, at step S304, the acquiring means 242 acquires, based on the request, from the webpage application 203 default CSS files for the web pages as a CSS template. Specifically, the webpage application 230 looks up resource data in the webpage application 230 by analyzing the request for CSS files, and then returns to the acquiring means 242 the found default CSS files for the web pages as the CSS file template for the web pages.

Next, at step S306, the generating means 243 updates the acquired CSS file template according to the personalized presentation rules associated with the current user preferences, so as to generate CSS files customized with respect to the current user. This will be described in detail hereinafter with reference to FIGS. 4 and 5.

At last, at step S308, the sending means 244 sends the customized CSS files to the browser 210 at the client 110. The browser 210 presents web pages according to the customized CSS files.

FIG. 4 is a schematic diagram showing the generating means 243 shown in FIG. 2 according to the embodiment of the present invention.

As shown in FIG. 4, the generating means 243 may comprise a parsing means 410, a computing means 412 and an updating means 416.

The parsing means 410 receives the CSS file template from the acquiring means 242, and parses the CSS file template to read various properties and their corresponding values in the CSS file template, and transfers the parsed result to the CSS computing means 412 as output data.

The computing means 412 receives the parsed properties and their previous values from the parsing means 412. For instance, the value of property “font size” is “normal size”, or the like. Additionally, the computing means 412 calculates current values of the parsed properties according to the personalized presentation rules corresponding to the preferences input by the user. For example, the personalized presentation rule corresponding to amblyopia is that the value of property “font size” is “200% of normal font size”. According to the rule, the computing means 412 may learn, by calculating, that the current value of the property “font size” is “200% of normal size”. It should be appreciated that the property “font size” is only an example of properties in the CSS files. The CSS files further comprise other properties, for instance color, layout, grey scale, background and the like.

And then, the updating means 416 replaces previous values with current values of properties from the computing means 412, for example, replaces “font size: normal size” with “font size: 200% of normal size”, and re-organizes each property, thereby acquiring the CSS files customized with respect to the user preferences.

A description of detailed operations of the generating means 243 in FIG. 4 is given with reference to FIG. 5.

At step S502, the parsing means 410 parses the CSS file template to obtain each property and the previous values of each property in the CSS file template.

At step S504, the computing means 412 calculates current values of the parsed properties according to the personalized presentation rules corresponding to the preferences input by the user.

At step S506, the updating means replaces the previous values of the parsed properties with the current values of the parsed properties, and re-combines each property, so as to acquire the customized CSS files. And then, the customized CSS files are transferred, via the sending means 244, to the browser 210 which presents web pages according to the customized CSS files.

According to the embodiment of the present invention, the server 104 can customize the CSS files with respect to the user based on the preferences input by the user, enabling presentation of web pages at the browser with the style desired by the user.

### A Second Embodiment

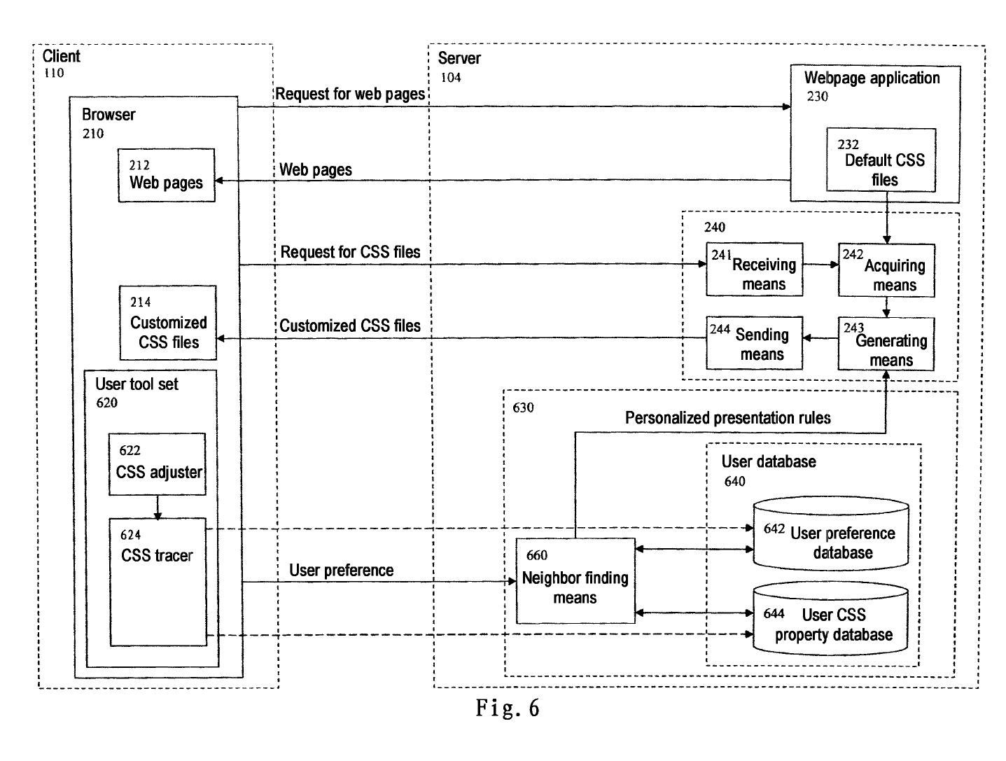

FIG. 6 is a schematic diagram showing the architectures of client and server sides of network architecture according to the second embodiment of the present invention. The differences between the network architecture of FIG. 6 and that of FIG. 2 mainly comprise the parts enclosed in a dashed line block 630, while other parts are similar. Each part similar to the one in FIG. 2 is no longer described herein.

According to the embodiment of the present invention, the customization of CSS files with respect to the current user preferences can be implemented without having the personalized presentation rules corresponding to the current user beforehand.

As shown in FIG. 6, in addition to parts which are the same as those in FIG. 2, the server 104 may further include a user database 640. The user database 640 may include a user preference database 642 for storing, in association with the user, the data of user preferences, and a user CSS file property database 644 for use in storing, in association with the user, the properties in the CSS files with respect to the user and their corresponding values.

The user preference data may include for example physical disability, gender, age, etc. For instance, the {amblyopia, male, 50} tuple may be utilized to stand for preference data of a man, 50, with a physical disability of amblyopia. The properties in the CSS files with respect to the user refer to the style for presenting the web pages for the user, for instance font, font color, background color, layout and the like. The user CSS file data property database 640 can be updated dynamically by using a CSS tracer 624 in a user tool set 620 described hereunder, and the updating process will be described in detail hereinafter.

Further, the server 104 may also include a neighbor finding means 660. The neighbor finding means 660 searches, from the user preference database 642, a neighbor user whose preferences are the most similar to the preferences input by the current user. Meanwhile, the neighbor finding means 660 may acquire, from the CSS property database 644 of the neighbor user, the properties in the presentation configuration files of the neighbor user, and provides the properties in the CSS files of the neighbor user as the personalized presentation rules of the current user. The generating means 243 may acquire the customized CSS files with respect to the user based on the personalized presentation rules.

According to this embodiment, the browser 210 may include a user tool set 620. The user tool set 620 may comprise a CSS adjuster 622 and a CSS tracer 624. The CSS adjuster 622 is an apparatus for a user to adjust the presentation style of the web pages at the browser 210. The user can adjust, by the CSS adjuster 622, various properties of the presentation style of the web pages (i.e., CSS properties), for instance defining the layout, background color, font color/font size/font style and other aspects of the web pages. Usually, during browsing the page documents, the user can adjust the CSS properties of the web pages presenting in real time according to his/her feeling at any moment through the CSS adjuster 622, for example, makes the font size of text in web pages 100% larger than the existing font size, sets the background color to white, etc. When the user completes the modification of CSS properties and confirms the updates, the updated CSS properties go into effect at once.

The CSS tracer 624 is for tracing history records of tuning the CSS properties of the web pages by the CSS adjuster 622, such as the CSS properties which have been set during adjusting the CSS properties and the values of these CSS properties. These updated CSS properties and their corresponding values will be stored in the user CSS property database 644 at the user database 640. Meanwhile, the CSS tracer 624 can trace the user preferences as well, and store the user and his/her new user preferences in the user preference database 642 correspondingly.

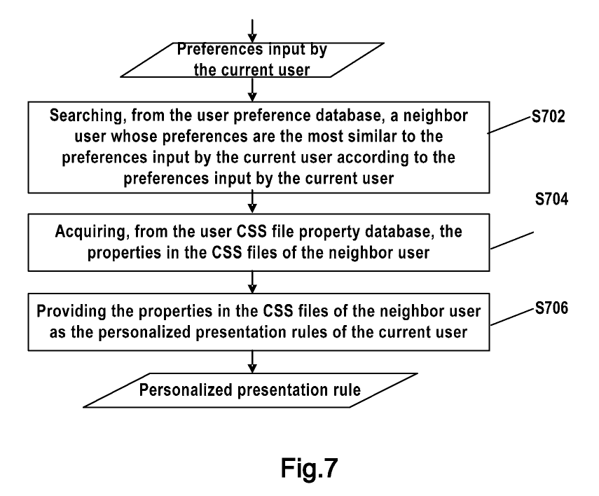

FIG. 7 is a flow chart showing a method for generating personalized presentation rules in accordance with the second embodiment of the present invention.

At step S702, the neighbor finding means 660 searches, from the user preference database 642, at least one neighbor user whose preferences are the most similar to the preferences input by the current user according to the preference data input by the current user.

Next, at step S704, the neighbor finding means 660 acquires, from the user CSS file property database 644, the properties in the CSS files of the at least one neighbor user and their corresponding values.

At last, at step S706, the neighbor finding means 660 provides the properties in the CSS files of the at least one neighbor user and their corresponding values as the personalized presentation rules of the current user. As described above, the generating means 243 can customize the CSS files for the user according to the personalized presentation rules.

Hereunder, a description of an example of generating the personalized presentation according to the second embodiment of the present invention is set forth.

It is assumed that the current user has a following preferences: “amblyopia, male, 50”. When the current user inputs the above preferences data at the browser 210, the browser 210 sends the preferences to the neighbor finding means 660. The neighbor finding means 660 searches user preferences which is the most similar to “amblyopia, male, 50” in the user preference database 642. For example, if the searched preference data “amblyopia, male, 51” is the most similar to the preference data of the current user, the user is deemed as the neighbor user. And then, the neighbor finding means 660 searches in the user CSS property database 644 the user name of the neighbor user (such as “user name: Zhang Ming”), and then finds that the user CSS properties and the corresponding values corresponding to the neighbor user are “font size/bold: 150% of normal font size/bold”. Thus, the neighbor finding means 660 transfers to the generating means 243 the user CSS property data “font size/bold: 150% of normal font size/bold” as the personalized presentation rules of the current user. The generating means 243 can customize the CSS files for the user according to the personalized presentation rules.

According to the second embodiment of the present invention, the customization of CSS files of the current user can be implemented by searching the CSS properties of the user whose preferences are the most similar to that of the current user and using the CSS properties of the neighbor user as the personalized presentation rules of the current user, without the history record of properties in the CSS files of the current user. Additionally, if there are a plurality of other user preferences similar to the current user preferences (provided that there are multiple users whose preferences are “amblyopia, male, 51”, and different users correspond to different CSS properties), the present invention can further estimate the multiple CSS properties and make a choice, thereby choosing the most suitable CSS properties (for instance, the CSS properties chosen by most of the users having same preferences) to customize the CSS files of the current user.

### Other Embodiments

In the first embodiment of the present invention as shown in FIG. 2, the receiving means 241, acquiring means 242, generating means 243 and sending means which are all enclosed in the dashed line block 240 and the preference database 245 are in a same server 104. That is, as shown in the first embodiment of the present invention shown in FIG. 2, the customization of the CSS files is implemented at the server 104 side.

In a variation of the first embodiment of the present invention, the receiving means 241, acquiring means 242, generating means 243 and sending means 244 which are all enclosed in the dashed line block 240 as shown in FIG. 2 are provided at the client 110 as well, to facilitate customizing the CSS files at the client side.

In another variation of the first embodiment of the present invention, the receiving means 241, acquiring means 242, generating means 243 and sending means 244 which are all enclosed in the dashed line block 240 as shown in FIG. 2 can also be provided at proxy servers (not shown) other than the server 104, such that the customization of the CSS files is implemented at the proxy servers.

In another variation of the first embodiment of the present invention, to satisfy real design requirements, the receiving means 241, acquiring means 242, generating means 243 and sending means 244 (which are all enclosed in the dashed line block 240 as shown in FIG. 2), can be provided at the server 104, client 210 and an intermediate proxy server respectively to implement a distributed arrangement.

Furthermore, in another variation of the first embodiment of the present invention, the preference database 245 can be provided at a proxy server (not shown) other than the server 104 or the client 110.

In the second embodiment of the present invention as shown in FIG. 6, the receiving means 241, acquiring means 242, generating means 243 and sending means 244 (which are all enclosed in the dashed line block 240), the user database 640, the neighbor finding means 660 and webpage application 230 are all provided at the same server 104. That is, as shown in the second embodiment of the present invention as shown in FIG. 6, the generation of the personalized presentation rules and the customization of the CSS files are implemented at the server 104 side.

In a variation of the second embodiment of the present invention, the receiving means 241, acquiring means 242, generating means 243 and sending means 244 (which are all enclosed in the dashed line block 240), the user database 640, the neighbor finding means 660 can be provided at a proxy server (not shown) other than the server 104, to implement the generation of personalized presentation rules and the customization of the CSS files at the proxy server.

In another variation of the second embodiment of the present invention, the receiving means 241, acquiring means 242, generating means 243, sending means 244 (which are all enclosed in the dashed line block 240), the user database 640, and the neighbor finding means 660 can be arranged following a distributed arrangement. For example, the receiving means 241, acquiring means 242, generating means 243, sending means 244 (which are all enclosed in the dashed line block 240) and the webpage application 230 may be located in a same server, while the user database 640 and the neighbor finding means 660 may be provided at another proxy server. Additionally, the user database 640 and the neighbor finding means 660 can be arranged in different servers.

Those skilled in the art should understand that, in real environments, the above-mentioned implementing manners and each feature and step in their variations can be combined at will, as long as the automatic customization of the CSS files based on the user preferences can be realized.

The present invention can be realized in multiple programming languages including but not limited to C, C++, Delphi, Visual Basic, etc.

The present invention can be implemented with hardware, software, firmware and their combinations. Those skilled in the art should be aware that the present invention can be also embodied in a computer program product set on a signal carrier media used by any suitable data processing system. This signal carrier media can be a transmission media or readable media of which the information can be readable by a machine, including magnetic media, optical media and other suitable media. Examples of recordable media comprises a disk or floppy in a hard disk driver, optical disk for optical driver, magnetic tape and other medium which can be imagined by those skilled in the art. Those skilled in the art should appreciate that any communication terminal with suitable programming apparatus will be able to implement the steps of the method of the present invention embodied in the program products.

It can be understood from the above-mentioned description that modifications and changes can be made on each embodiment of the present invention without departing from the spirit of the present invention. The description in this Description is only for illustration, but not for limitation. The scope of the present invention is only limited by the appended claims.

1. A method for generating a presentation configuration file of document content, wherein said document content will be presented according to said presentation configuration file, the method comprising the steps of:
acquiring one presentation configuration file template; and
updating said presentation file template according to personalized presentation rules associated with preferences input by a current user, to generate the presentation configuration file customized with respect to said current user.

2. The method of claim 1, wherein said generating step further comprises:
parsing said acquired presentation configuration file template to acquire one or more properties in the presentation configuration file template and corresponding previous values for said one or more properties;
calculating current values of said one or more properties according to said personalized presentation rules; and
using the current values of said one or more properties to update the previous values of said one or more properties, to acquire said customized presentation configuration file.

3. The method of claim 1, further comprising the steps of:
receiving from a client a request for a presentation configuration file; and
based on the request, acquiring a default presentation configuration file from an application as said presentation configuration file template.

4. The method of claim 3, further comprising the steps of:
sending said customized presentation configuration file to said client such that the document content is presented at said client according to the customized presentation configuration file.

5. The method of claim 1, further comprising the steps of:
providing a preference database for storing personalized presentation rules in association with the preferences;
wherein said personalized presentation rules are acquired from the preference database according to the preferences input by the user.

6. The method of claim 1, further comprising the steps of:
providing a user preference database for storing, in association with the user, the user preferences; and
providing a user presentation configuration file property database, for storing, in association with the user, one or more properties in the presentation configuration file of the user and corresponding property values for said one or more properties.

7. The method of claim 6, further comprising the steps of:
searching, according to the preferences input by the current user, neighbor users whose preferences are similar to said preferences input by the current user from the user preference database; and
acquiring, from the user presentation configuration file property database, properties in at least one presentation configuration file of at least one the neighbor user and corresponding property values,
wherein said properties in the at least one presentation configuration file of the neighbor users and their corresponding values are provided as said personalized presentation rules.

8. The method of claim 6, wherein said user presentation configuration file property database is updated with the properties in the current presentation files of the user acquired from the client.

9. The method of claim 1, wherein said preference comprises at least one of amblyopia, red-green color blindness, gender and age.

10. A method for generating personalized presentation rules comprising the steps of:
providing a user preference database for storing, in association with a user, user preferences;
providing a user presentation configuration file property database, for storing, in association with the user, properties in the presentation configuration files of the user and their corresponding values;
searching, according to the preferences input by the current user, at least one neighbor user whose preferences are similar to the preferences input by the current user from said user preference database; and
acquiring, from the user presentation configuration file property database, properties in at least one presentation configuration files of the neighbor users and corresponding property values,
wherein the properties in said presentation configuration files of the neighbor users and their corresponding property values are provided as personalized presentation rules.

11. An apparatus for generating presentation configuration files of document content, wherein said document content will be presented according to said presentation configuration files, the apparatus comprising:
an acquiring means for acquiring one presentation configuration file template; and
a generating means for updating said presentation file template according to personalized presentation rules associated with preferences input by the current user, to generate the presentation configuration files customized with respect to the current user.

12. The apparatus of claim 11, wherein said generating means further comprises:
a parsing means for parsing said acquired presentation configuration file template, to acquire several properties in the presentation configuration file template and corresponding previous property values;
a computing means for calculating current values of said properties according to said personalized presentation rules; and
an updating means for using the current values of said properties to update the previous property values to acquire said customized presentation configuration files.

13. The apparatus of claim 11, further comprising:
a receiving means for receiving a request for presentation configuration files from a client;
wherein, based on the request, said acquiring means acquires default presentation configuration files from an application as said presentation configuration file template.

14. The apparatus of claim 13, further comprising:
a sending means for sending said customized presentation configuration files to the client such that the document content is presented at said client according to the customized configuration files.

15. The apparatus of claim 11, further comprising:
a preference database for storing, in association with, the personalized presentation rules the preferences;
wherein the personalized presentation rules are acquired from the preference database according to the preferences input by the user.

16. The apparatus of claim 11, further comprising:
a user preference database for storing, in association with the user, the user preferences; and
a user presentation configuration file property database, for storing, in association with the user, properties in the presentation configuration files of the user and their corresponding values.

17. The apparatus of claim 16, further comprising:
neighbors finding means for searching, based on the preferences input by the current user, neighbor users whose preferences are similar to said preferences input by the current user from the user preference database, and acquiring said properties in the presentation configuration files of the neighbor users and their corresponding values from the user presentation configuration file property database,
wherein the properties in the presentation configuration files of the neighbor users and their corresponding values are provided as said personalized presentation rules.

18. The apparatus of claim 16, wherein said user presentation configuration file property database is updated with the properties in the current presentation files of the user acquired from the client.

19. The apparatus of claim 11, wherein the preference comprises at least one of amblyopia, red-green color blindness, gender and age.

20. An apparatus for generating personalized presentation rules used in the apparatus of claim 11, comprising:
a user preference database for storing, in association with the user, the user preferences;
a user presentation configuration file property database, for storing, in association with the user, properties in the presentation configuration files of the user and their corresponding values;
a neighbor finding means for searching, based on the preferences input by the current user, a neighbor user whose preferences are the most similar to said preferences input by the current user from said user preference database, and acquiring properties in the presentation configuration files of said neighbor user and their corresponding values from said user presentation configuration file property database,
wherein the properties in the presentation configuration files of said neighbor user and their corresponding values are provided as said personalized presentation rules of said current user.
